(19) United States
(12) Patent Application Publication
(10) Pub. No.: US 2024/0041046 A1
(43) Pub. Date: Feb. 8, 2024

(54) METHODS AND COMPOSITIONS OF A LIQUID CONTROLLED-RELEASE PESTICIDE FOR TARGETED DELIVERY AND DRIFT REDUCTION

(71) Applicant: SePRO Corporation, Carmel, IN (US)

(72) Inventors: Ben WILLIS, Rocky Mount, NC (US); West M. BISHOP, Kings Mountain, NC (US); Byran C. FUHRMANN, Rocky Mount, NC (US); Chase KILGORE, Rocky Mount, NC (US)

(21) Appl. No.: 18/223,632

(22) Filed: Jul. 19, 2023

Related U.S. Application Data
(60) Provisional application No. 63/394,353, filed on Aug. 2, 2022.

(51) Int. Cl. A01N 59/20; A01N 25/04; A01P 13/00; A01N 43/40; A01N 43/12

(52) U.S. Cl. CPC A01N 59/20; A01N 25/04; A01P 13/00; A01N 43/40; A01N 43/12

(57) ABSTRACT

Controlled-release liquid pesticide formulation that provide extended release, reduction in pesticide drift, and target control of invasive aquatic macrophytes, macroalgae, and/or benthic algae or cyanobacteria. In one embodiment, controlled-release liquid pesticide formulations include an active ingredient associated with or bound to a carrier and suspended in a liquid medium. In another embodiment, controlled-release liquid pesticide formulations comprise: a pesticide associated with a non-aqueous liquid or solid complex precipitates when applied to water bodies.

### CROSS-REFERENCE TO RELATED APPLICATIONS

This Application is related to and claims priority to U.S. Provisional Pat. App. No. 63/394,353, filed Aug. 2, 2023, entitled METHODS AND COMPOSITIONS OF A LIQUID CONTROLLED-RELEASE PESTICIDE FOR TARGETED DELIVERY AND DRIFT REDUCTION, the entirety of which is incorporated herein by reference.

### GOVERNMENT RIGHTS STATEMENT

N/A.

### TECHNICAL FIELD

This disclosure relates to methods of production and use of a liquid controlled-release aquatic pesticide formulation that contains a carrier (which may be water insoluble in formulation) with an active ingredient, allowing for extended contact time and the targeted delivery of the pesticide for the control of invasive aquatic macrophytes, macroalgae, and/or benthic algae or cyanobacteria. Such compositions generally include an active ingredient associated with or bound to a non-aqueous solid carrier and formed as a micro- or nanoparticulate material in an aqueous liquid, or an active ingredient combined with a non-aqueous liquid carrier in an aqueous liquid. In some embodiments, the liquid controlled-release formulation may be a concentrated solution that may be applied directly or diluted before application.

### BACKGROUND

Aquatic pests such as nuisance macrophytes and algae often grow at exceedingly rapid rates in water bodies. The control of aquatic pests requires different considerations than the control of terrestrial weeds, as water may affect distribution, dissolution, and application of the material. Liquid pesticides (e.g., liquid herbicides and algaecides) are commonly used for the control of aquatic pests to restore water uses. These products are less effective in flowing and open waters such as the middle of a lake or canal, due to rapid dilution and drift away from the pest. This drift consequently creates undesired exposure to non-target organisms such as fish and invertebrates.

Solid granular controlled-release pesticide formulations are commonly used in agriculture and other terrestrial situations. Granular controlled-release pesticide formulations (e.g., granular controlled-release herbicides and algaecides) are used to prolong contact time of the active ingredient with the target pest and to control release rate, and these formulations are more effective in flowing waters or surface waters with low residence times. Granular aquatic herbicides and algaecides also reduce the potential for pesticidal drift away from the target pest by releasing pesticide directly on the target. However, granular pesticides are more difficult to apply when compared to liquid formulations, and require specialized equipment for the treatment of large water bodies. Commonly, granular pesticides have a lower overall concentration of the active ingredient compared to liquid pesticides. Therefore, a greater amount of the granular pesticide is typically required to adequately cover a given treatment area. The greater bulk needed for granular aquatic pesticide applications can be problematic for shipping and transporting the pesticide on and to the water body. Granular pesticides frequently release dust during the application process and increase applicator exposure to pesticides, while liquid pesticides can be applied under the water surface and do not come in contact with the applicator. Additionally, pellets tend to sink into aquatic sediments, rather than remain on top of the sediment, which can reduce contact with the target organism as well as deactivate the active ingredient through sediment sorption to the extent that the target pest is not controlled. The combined use of liquid and granular pesticides is a popular strategy for complete control of aquatic pests. However, such combined use typically requires specialized equipment or additional personnel and time.

### SUMMARY

Some embodiments advantageously provide a controlled-release liquid pesticide that contains a carrier (which may be water insoluble in formulation) with an active ingredient, allowing for extended contact time and the targeted delivery of the pesticide for the control of invasive aquatic macrophytes, macroalgae, and/or benthic algae or cyanobacteria.

In one embodiment, a controlled-release liquid pesticide formulation includes: an active ingredient; and a non-aqueous carrier, the non-aqueous carrier including a plurality of particles having a size of between approximately 1 μm to approximately 1,000 μm.

In one aspect of the embodiment, the non-aqueous carrier includes a polymer, the non-aqueous carrier being suspended within a liquid.

In one aspect of the embodiment, the active ingredient is a pesticide.

In one aspect of the embodiment, the active ingredient is at least one of an aquatic herbicide and an algaecide.

In one aspect of the embodiment, the active ingredient is at least one active ingredient selected from the group consisting of: diquat dibromide, endothall, dipotassium salts of endothall, amine salts of endothall, copper, copper sulfate, copper chelated with ethylenediamine, copper chelated with monoethanolamine, copper chelated with triethanolamine, carfentrazone-ethyl, flumioxazin, 2,4-D, acids of 2,4-D, amine salts of 2,4-D, esters of 2,4-D, triclopyr, acids of triclopyr, amines of triclopyr, choline salts of triclopyr, glyphosate, imazapyr, imazamox, penoxsulam, fluridone, topramezone, bispyribac-sodium, sethoxydim, florpyrauxifen-benzyl, metsulfuron-methyl, and fluazifop-P-butyl.

In one aspect of the embodiment, the non-aqueous carrier is at least one of the following: a synthetic polymer, a natural polymer, a derivative of a natural polymer, a fatty acid, a mixture of fatty acids, a lipid, a lipid derivative, a hydrocarbon, a hydrocarbon derivative, an alcohol, an alcohol derivate, a sterol, a sterol derivative, a soap, a saponin, a soap derivative, a saponin derivative, a flavone, and a flavone derivative, and mixtures thereof.

In one aspect of the embodiment, the non-aqueous carrier is at least one of polyacrylate, polyvinyl acetate, a polydimethylsiloxane, a metasilicate, alginate, cellulose, chitin, latex, animal glue, collagen, methylcellulose, chitosan, gelatin, animal fat, vegetable oil, seed oil, a fatty acid metal complex, an esterified lipid, wax, petroleum distillate, an essential oil, glycerol-modified hydrocarbon.

In one aspect of the embodiment, the controlled-release liquid pesticide formulation further includes water, the active ingredient being bound to the plurality of particles of the non-aqueous carrier, the active ingredient and the plurality of particles of the non-aqueous carrier being suspended in the water.

In one aspect of the embodiment, the controlled-release liquid pesticide formulation is configured such that the active ingredient accumulates in a bottom water or at a sediment-water interface relative to a standard liquid pesticide.

In one embodiment, the active ingredient is ethylenediamine chelated copper and the non-aqueous carrier includes potassium polyacrylate.

In one embodiment, the controlled-release liquid pesticide formulation further includes an antifoam agent.

In one aspect of the embodiment, the controlled-release liquid pesticide formulation is formulated such that the active ingredient is released from the controlled-release liquid pesticide formulation slowly over time to reduce off-site drift and/or diffusion into the water column of the pesticide active ingredient.

In one aspect of the embodiment, the active ingredient is fluridone and the non-aqueous carrier includes tall oil and calcium carbonate.

In one aspect of the embodiment, the non-aqueous carrier further includes at least one of a dispersing agent, an antimicrobial agent, an antifoam agent, and a thickener.

In one aspect of the embodiment, the active ingredient is endothall and the non-aqueous carrier includes potassium polyacrylate.

In one aspect of the embodiment, the carrier further includes at least one of poldimethylysiloxane, xanthan gum, and polyoxyethylene isotridecyl ether.

In one embodiment, a controlled-release liquid pesticide formulation includes: an active ingredient, the active ingredient being ethylenediamine chelated copper; and a non-aqueous carrier, the non-aqueous carrier including a plurality of particles having a size of between approximately 1 μm to approximately 1,000 μm, the non-aqueous carrier including potassium polyacrylate, the controlled-release liquid pesticide formulation having a form of sprayable pellets.

In one aspect of the embodiment, the controlled-release liquid pesticide formulation further includes water and an antifoam agent, wherein: the ethylenediamine chelated copper is present in an amount of approximately 20-23% by weight; the potassium polyacrylate is present in an amount of approximately 1-3%; the antifoam agent is present in an amount of approximately 0.1-2%; and the water is present in an amount of approximately 60-80%.

In one embodiment, a controlled-release liquid pesticide formulation includes: an active ingredient, the active ingredient being fluridone; and a non-aqueous carrier, the non-aqueous carrier including a plurality of particles having a size of between approximately 1μm to approximately 1,000 μm, the non-aqueous carrier including tall oil and calcium carbonate.

In one aspect of the embodiment, the controlled-release liquid pesticide formulation further includes water, and the non-aqueous carrier further including at least one of ethoxylated tridecanol, 1,2-benzisothiazol-3(2H)-one, 5-chloro-2-methyl-2H-isothiazolin-3-one, polydimethylsiloxane, and xanthan gum, wherein: the fluridone is present in an amount of approximately 41.7%; the tall oil is present in an amount of approximately 7%; the calcium carbonate is present in an amount of approximately 5%; and the water is present in an amount of approximately 45.2%.

In one embodiment, a controlled-release liquid pesticide formulation includes: an active ingredient, the active ingredient being endothall; and a non-aqueous carrier, the non-aqueous carrier including a plurality of particles having a size of between approximately 1 μm to approximately 1,000 μm, the non-aqueous carrier including potassium polyacrylate.

In one aspect of the embodiment, the controlled-release liquid pesticide formulation further includes water, and the non-aqueous carrier further including at least one of polydimethylsiloxane, xanthan gum, and polyoxyethylene isotridecyl ether wherein: the endothall is present in an amount of approximately 40.3%; and the potassium polyacrylate is present in an amount of approximately 4%.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 is a chart showing a comparison of experimental data of copper concentrations (mg Cu/L) between bottom waters treated with an exemplary formulation containing a polyacrylate carrier and a liquid copper pesticide without polyacrylate carrier;

FIG. 2 is a chart showing a linear interpolation to derive a normalized percent of total copper at a plurality of water depths at two hours after treatment of the water with an exemplary formulation containing a polyacrylate carrier and a liquid copper pesticide without polyacrylate carrier;

FIG. 3 is a graph showing a comparison of experimental data of copper concentrations (mg Cu/L) between an exemplary formulation containing a polyacrylate carrier and a liquid copper pesticide without polyacrylate carrier, measuring the copper release from carrier by transferring the bottom 5 mL of a treated solution from one borosilicate cone tube to another three times over five minutes;

FIG. 4 is a graph showing comparison of experimental data of fluridone concentrations (μg/L) between exemplary formulations containing a tall oil calcium carbonate carrier and a liquid without tall oil calcium carrier, and a traditional pelletized fluridone formulation measured at 0, 1, 7, 14, 21, 28, 42, 56, and 70 days after treatment; and

FIG. 5 is a graph showing comparison of experimental data of endothall concentrations (mg/L) between exemplary formulation containing endothall with polyacrylate carrier and a liquid without polyacrylate carrier, measuring the endothall release from carrier by transferring the bottom 5 mL of a treated solution from one borosilicate cone tube to another three times over five minutes.

### DETAILED DESCRIPTION

Before describing in detail exemplary embodiments, it is noted that the embodiments reside primarily in combinations of apparatus components and steps related to methods and formulations of a liquid controlled-release pesticide for targeted delivery and drift reduction. Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In one embodiment, a controlled-release liquid pesticide formulation (which may be referred to herein as “liquid formulation” for simplicity) as disclosed herein displays spatial targeting (that is, demonstrates targeted delivery of the active ingredient or pesticide in that the liquid formulation is formulated for enhanced contact time with the target pest species), and is formulated such that the release rate of the active ingredient in the liquid formulation is slowed, and the formulation material precipitates onto the target submerged aquatic macrophyte or algae to provide more precise control of target species. Additionally, in one embodiment the liquid formulation retains a high active ingredient loading to avoid bulk that creates logistical issues. In one embodiment the liquid formulation is formulated such that a carrier in the liquid formulation adheres to the active ingredient and sinks. The controlled-release liquid formulation is a “sprayable pellet,” in that it includes solid particles that display the controlled-release qualities of a granular formulation, but the formulation is sprayable like a liquid formulation. So, although referred to herein as a “liquid formulation,” it will be understood that the controlled-release liquid formulation disclosed herein displays qualities of both granular formulations and liquid formulations. For example, the liquid formulation provides the ease of application of liquid pesticides combined with the extended contact time of granular pesticides.

In some embodiments, the liquid formulation is a controlled-release liquid formulation that includes a first amount of at least one active ingredient that is an aquatic pesticide and a second amount of a carrier. In one embodiment, the aquatic pesticide is at least one of an herbicide and an algaecide. In one embodiment, the carrier is water insoluble. In one embodiment, the carrier is water insoluble and is suspended in an aqueous solution. The carrier may be a liquid or solid that is capable of being associated with or bound to the active ingredient and that reduces the solubility or release rate of the active ingredient when applied to a body of water. In one embodiment, the carrier includes more than one ingredient. In one embodiment, the carrier is a solid micro- or nanoparticulate material to which the active ingredient is bound or with which the active ingredient is associated, and the combined active ingredient and carrier are suspended in an aqueous solution. Additionally or alternatively, in some embodiments the carrier is a liquid, gel, or other non-solid material, with the active ingredient being bound, dissolved, associated, carried, or otherwise combined with the carrier, and the combined active ingredient and carrier are suspended in an aqueous solution, such as water, an acidic solution, a basic solution, or a salt containing solution.

In some embodiments, the at least one active ingredient includes, but is not limited to, oxidizers such as peroxide, diquat dibromide, endothall (dipotassium and amine salts as well as the acid form), copper (when used as an herbicide, such as copper sulfate or various chelated forms including, but not limited to, complexes with ethylenediamine, monoethanolamine, and triethanolamine), carfentrazone-ethyl, flumioxazin, 2,4-D (various forms approved for aquatic use, including acid, amine salts and esters), triclopyr (acid, amine and choline salts), glyphosate, imazapyr, imazamox, penoxsulam, fluridone, topramezone, bispyribac-sodium, sethoxydim, florpyrauxifen-benzyl, metsulfuron-methyl, fluazifop-P-butyl. Exemplary active ingredients (aquatic pesticides) and target aquatic pests are shown below in Table 1:

TABLE 1
Exemplary active ingredients.

| Pesticide | Target Aquatic Pest |
|---|---|
| Oxidizers, such as peroxide | Algae and bacteria |
| Endothall compounds | Macrophytes and algae |
| Copper complexes | Macrophytes, algae, |
| | bacteria, and invertebrates |
| Carfentrazone-ethyl | Macrophytes and algae |
| Diquat | Macrophytes and algae |
| Flumioxazin | Macrophytes and algae |
| 2,4-D compounds | Macrophytes |
| Triclopyr complexes | Macrophytes |
| Glyphosate | Macrophytes |
| Imazapyr | Macrophytes |
| Imazamox | Macrophytes |
| Penoxsulam | Macrophytes |
| Fluridone | Macrophytes |
| Topramezone | Macrophytes |
| Bispyribac-sodium | Macrophytes |
| Sethoxydim | Macrophytes |
| Florpyrauxifen-benzyl | Macrophytes |
| Metsulfuron-methyl | Macrophytes |
| Fluazifop-P-butyl | Macrophytes |

In some embodiments, the carrier is or includes non-aqueous liquid or solid carriers. In one embodiment, the carrier includes, but is not limited to, minerals such as a phyllosilicates, divalent and trivalent metal complexes such as magnesium oxide and aluminum sulfate, synthetic polymers such as polyacrylate, polyvinyl acetate, polydimethylsiloxanes or metasilicates; natural polymers such as alginate, cellulose, chitin, latex, animal glue, or collagen or derivatives of natural polymers such as methylcellulose, chitosan, or gelatin; lipids such as animal fat, vegetable or seed oil or lipids derivatives such as fatty acid metal complexes or esterified lipids; hydrocarbons such as wax, petroleum distillates, or essential oils or hydrocarbon derivatives such as a glycerol-modified hydrocarbons, alcohols or alcohol derivatives, sterols or sterol derivatives such as cholesterol, soaps, saponins, and derivatives such as glycyrrhizin, flavones and derivatives such as quercetin or epigallocatechin gallate (EGCG), and combinations thereof. As used herein, the term “glycerol-modified” refers to a compound in which a glycerol molecule has been chemically bound. For example, glycerol-modified oleate refers to an oleate molecule with one or more chemically bound glycerol molecules. In some embodiments, the carrier is present in the liquid formulation as microparticles (approximately 1 μm to approximately 1,000 μm in diameter) or nanoparticles (less than approximately 1 μm in diameter) suspended in solution. In some embodiments, the carrier is a water-insoluble solid, liquid, gel, or other material. In other embodiments, the carrier includes at least one water-soluble material, but is water-insoluble overall because of other water-insoluble materials in the carrier and/or the carrier is rendered water insoluble in the liquid formulation when combined with the active ingredient and/or other carrier ingredients. Thus, the carrier as included in the final liquid formulation is referred to herein as water insoluble, regardless of the native solubility of the carrier ingredient itself when considered alone. In some embodiments, the water-insoluble carrier absorbs or encapsulates the active ingredient(s) and acts to control or delay the release of active ingredient(s) in the liquid formulation.

In some embodiments, the controlled-release liquid formulation includes additional ingredients, such as adjuvants, spreaders, dispersing agents, antimicrobials, antifoam agents, thickeners, diluents, inert ingredients, or other ingredients that do not affect binding between the active ingredient(s) and the carrier(s) and/or the water-insoluble nature of the carrier(s).

Non-limiting examples of controlled-release liquid formulations are discussed in the Examples below.

### EXAMPLE 1

In a first non-limiting example (Example 1), the controlled-release liquid formulation is a controlled-release liquid aquatic pesticide formulation that includes ethylenediamine chelated copper as the active ingredient and polyacrylate in the carrier (“Example 1 Controlled-Release Liquid Formulation”). In one aspect of the embodiment, the controlled-release liquid formulation is approximately 60-80% water, as well as approximately 20-23% ethylenediamine chelated copper and approximately 1-3% potassium polyacrylate together formed as particles having a particle size of greater than approximately 250 μm and less than approximately 1000 μm (±25 μm), with the particles being suspended in the water, and the water having a pH of 7-8. In some embodiments, the controlled-release liquid formulation also includes approximately 0.1-2% antifoam agent, which may prevent the particles from having air bubbles that cause flotation of the particles. In some embodiments, the antifoam agent is at least one of polydimethylsiloxane and isopropyl alcohol. However, it will be understood that other suitable antifoam agents could be used in addition to or instead of these.

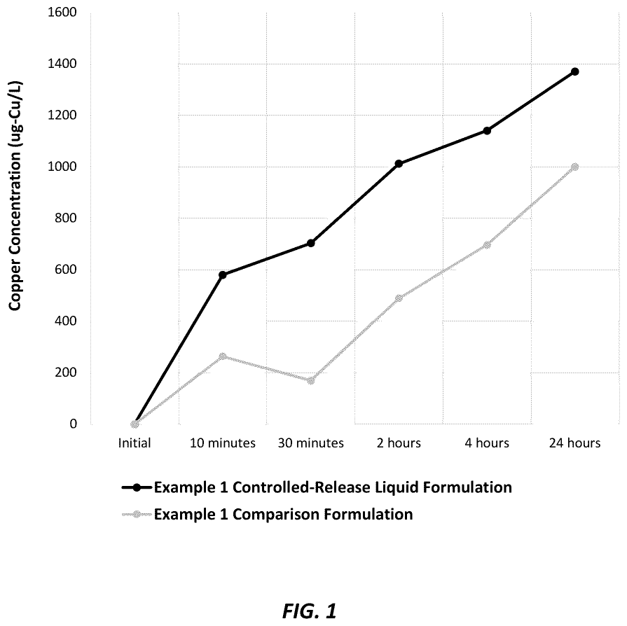

In a first experiment in Example 1, rectangular prism acrylic tanks with dimensions of 154.31 cm in height and 21.91 cm in length and width were filled to 144.15 cm with well water (69.18 L). Temperature was allowed to acclimate to ambient conditions for three days and tanks were mixed with a pump to homogenize temperature prior to experimentation. One tank was treated at 1 mg Cu/L with Example 1 Controlled-Release Liquid Formulation and an adjacent tank was treated at 1 mg Cu/L with copper pesticide containing no potassium polyacrylate (KOMEEN®, SePRO Corporation, Indiana; the “Example 1 Comparison Formulation”). Both products contained 8% elemental copper (or approximately 97.6 g Cu/L). 0.71 mL of each formulation was amended to achieve target concentrations in corresponding tanks. Copper samples were collected at different depths within each individual treatment tank after treatment at 10 cm, 30 cm, 60 cm, 90 cm, and 130 cm from the bottom using a syringe attached to PVC piping to sample at specific depths. Care was taken to minimize any mixing within each tank. Samples were taken pre-treatment and at 10 mins, 30 mins, 2 mins, 4 mins, and 24 hours after treatment. A comparison of copper concentrations (μg Cu/L) in bottom water (10 cm and 30 cm from the bottom, with values averaged) is shown in FIG. 1. As indicated by the data shown in FIG. 1, the average bottom water copper concentration was substantially higher for the application of Example 1 Controlled-Release Liquid Formulation (which includes both copper as active ingredient and polyacrylate as the carrier) than the Example 1 Comparison Formulation.

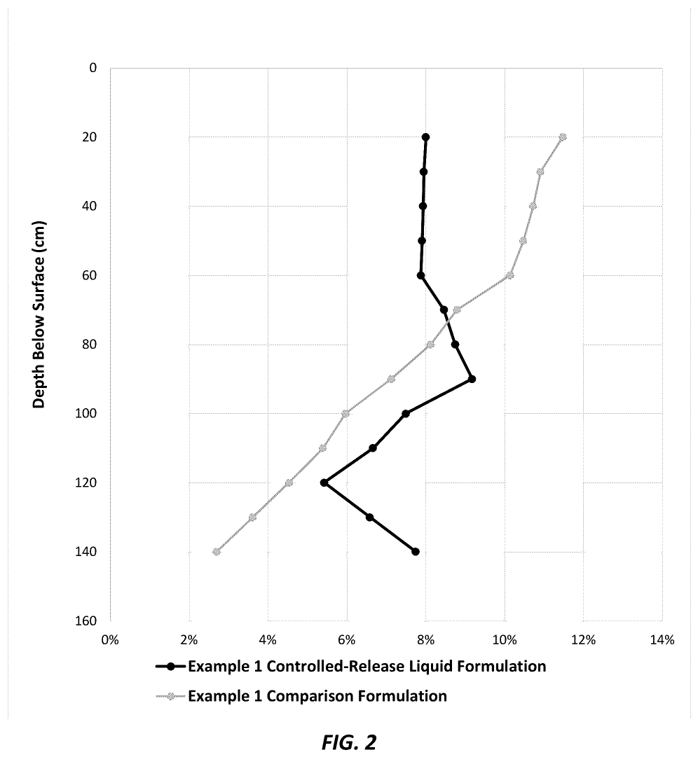

Continuing to refer to the first experiment in Example 1, further data analysis was performed, and all depths of the column were linearly interpolated by averaging the concentration between each sample location for the water column of each treatment to obtain twelve evenly spaced copper concentrations every 10 cm, from 10 cm to 130 cm from the bottom of the tank, at each sampling time period. The sum of the twelve data points was calculated for each treatment at each time period, and the percentage of the total concentration was calculated for each 10 cm incremental depth. These data are shown for the 2-hour time point in FIG. 2, demonstrating that the Example 1 Controlled-Release Liquid Formulation (copper with a polyacrylate carrier) delivered a substantially higher percent of the total copper to the bottom of the tank compared to the Example 1 Comparison Formulation, which primarily delivered copper to the surface water, with the copper concentration linearly decreasing with depth. Therefore, in some embodiments application of the controlled-release liquid formulation disclosed herein (for example, the Example 1 Controlled-Release Liquid Formulation) will result in an accumulation (a greater concentration) of active ingredient(s) at or near the bottom of the body of water being treated, which increases the exposure of aquatic pests such as submerged aquatic macrophytes or algae to the active ingredient(s).

In a second experiment in Example 1, the release profile of the Example 1 Controlled-Release Liquid Formulation was compared with a standard liquid copper pesticide (KOMEEN®, the Example 1 Comparison Formulation). A specific amount of the Example 1 Controlled-Release Liquid Formulation (102 μL) was added to a first initial 100-mL borosilicate glass short cone oil centrifuge tube containing 100 mL of nanopure water (water purified using a Barnstead/Thermolyne Nanopure lab water system), and a specific amount of the Example 1 Comparison Formulation liquid copper pesticide (102 μL) was added to another initial 100-mL borosilicate glass short cone oil centrifuge tube containing 100 mL of nanopure water. These amounts would be equivalent to a theoretical target treatment concentration of 100 mg Cu/L. Immediately after addition, a glass stopper was placed on each initial tube and the initial tubes were then gently inverted 180° . After 30 seconds following the inversion, the bottom 5 mL of liquid in the tube was pipetted into a different, untreated tube containing 95 mL nanopure water (second tube). Each of these different tubes were similarly capped and inverted 180° and a 5-mL aliquot was collected at 30 seconds and transferred to another different, untreated tube containing 95 mL nanopure water (third tube).

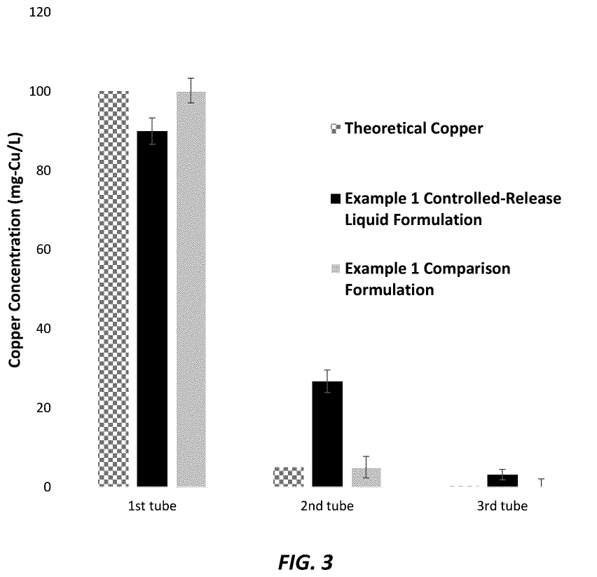

Continuing to refer to this second experiment in Example 1, copper samples were collected five minutes and at two hours after addition to each tube. Tubes were homogenized prior to sampling at each post-treatment time point. This experiment was conducted three times in sequence and the average concentration is shown by the bar height, while the error bars represent the minimum and maximum values (FIG. 3). Copper was measured on the ICP-OES. Samples were acidified to 2% HNO₃ (TRACEMETAL™ GRADE, Fisher Scientific, Massachusetts, US; “TMG”) as well as diluted in a 2% TMG HNO₃ matrix (if needed) to ensure results fell within the standard quantification range (5-1,000 μg Cu/L). Copper was then compared between treatment with the Example 1 Controlled-Release Liquid Formulation and the Example 1 Comparison Formulation.

Continuing to refer to this second experiment in Example 1, the copper concentrations for the first tube treated with the Example 1 Controlled-Release Liquid Formulation were significantly below the targeted concentration as well as the concentration of copper for the first tube treated with the Example 1 Comparison Formulation (100 mg/L), suggesting that carrier material (containing copper) had settled to the bottom of the tube and was transferred. These measurements agree with visual observations. The Example 1 Controlled-Release Liquid Formulation had a copper concentration that was approximately 5.3 times greater than the theoretical concentration in the second tube and approximately 12.7 times greater than the theoretical concentration in the third tube, and both of which were significantly higher than copper concentrations in the second and third tubes for the Example 1 Comparison Formulation. These results are shown in FIG. 3. This study shows a controlled release of copper from the Example 1 Controlled-Release Liquid Formulation, due to its association with or binding by the carrier, in contrast with the theoretical results and the liquid copper pesticide (Example 1 Comparison Formulation).

In a third experiment in Example 1, rectangular prism acrylic tanks with dimensions of 154.31 cm in height and 21.91 cm in length and width were filled to 144.15 cm with well water (69.18 L). Temperature was allowed to acclimate to ambient conditions for three days and tanks were mixed with a pump to homogenize temperature prior to experimentation. Chara sp. (macroalga) was collected from ponds in Whitakers, North Carolina and placed in growth planters. Topsoil amended with OSMOCOTE® (Everris International B.V., Netherlands) with a sand cap was used. Approximately ten Chara stems per container, following acclimation, were gently placed in these tanks. A first tank was treated at 1 mg Cu/L with the Example 1 Controlled-Release Liquid Formulation, a second tank was treated with 1 mg Cu/L with liquid copper pesticide containing no potassium polyacrylate (KOMEEN®, the Example 1 Comparison Formulation), and a third tank was used as an untreated control. Both formulations contained 8% elemental copper (or approximately 97.6 g Cu/L). 0.71 mL of each formulation was amended to achieve target concentrations in corresponding tanks. Copper samples were collected within each of the three tanks after treatment at 30 cm from the bottom using a syringe attached to PVC piping to sample at specific depths. Care was taken to minimize any mixing within the tanks. Samples were collected pre-treatment, at 30 minutes after treatment, and at three days after treatment. Subsamples of Chara biomass (at 0.1-0.2 grams fresh weight) was collected at four days after treatment. The biomass was rinsed with deionized water, blotted gently on a paper towel, and placed in a centrifuge tube and digested with TMG HNO3 and hydrogen peroxide (per Environmental Protection Agency Test Method 3052). Samples were then diluted with nanopure water and analyzed on the ICP-OES to measure copper content. Copper concentration measurements taken from the bottom of the tanks at 30 minutes were 7 μg/L, 72 μg/L, and 188 ug/L, respectively, in the control, the Example 1 Comparison Formulation, and the Example 1 Controlled-Release Liquid Formulation treatments, showing that a much higher copper concentration in the bottom water is present in the short term after application of the Example 1 Controlled-Release Liquid Formulation than after application of the Example 1 Comparison Formulation. By three days after treatment, the copper concentrations were similar between the Example 1 Comparison Formulation (826 ug/L) and the Example 1 Controlled-Release Liquid Formulation (875 ug/L). Chara tissue treated with the Example 1 Controlled-Release Liquid Formulation had 0.23 mg Cu/g sorbed at four days after treatment, whereas Chara tissue treated with the Example 1 Comparison Formulation had only 0.15 mg Cu/g at four days after treatment (control was 0.014 mg Cu/g), showing that the Example 1 Controlled-Release Liquid Formulation delivered more copper to the target plant biomass.

EXAMPLE 2

In a second non-limiting example (Example 2), the controlled-release liquid formulation is a controlled-release liquid aquatic pesticide that includes fluridone as the active ingredient and tall oil in the carrier (“Example 2 Controlled-Release Liquid Formulation”). In one embodiment, the controlled-release liquid formulation further includes at least one additional ingredient. In one embodiment, the additional ingredient is at least of one of a dispersing agent, an antimicrobial agent, an antifoam agent, and a thickener. In one non-limiting example, the controlled-release liquid formulation is approximately 41.7% (±2%) fluridone, and approximately 7% (±0.5%) tall oil suspended in approximately 46.3% (±2%) water containing approximately 5% (±0.5%) calcium carbonate (“Example 2-1 Controlled-Release Liquid Formulation”). In one aspect of the embodiment, the controlled-release liquid formulation is approximately 41.7% (±2%) fluridone, 45.2% (±2%) water, 7% (±0.5%) tall oil, 5% (±0.5%) calcium carbonate, 0.25% (±0.05%) ethoxylated tridecanol (for example, as a dispersing agent), 0.2% (±0.05%) 1,2-benzisothiazol-3(2H)-one (for example, as an antimicrobial agent), 0.05% (±0.005%) 5-chloro-2-methyl-2H-isothiazolin-3-one, 0.3% (±0.05%) polydimethylsiloxane (for example, as an antifoam agent), and 0.3% (±0.05%) xanthan gum (for example, as a thickener) (“Example 2-2 Controlled-Release Liquid Formulation”).

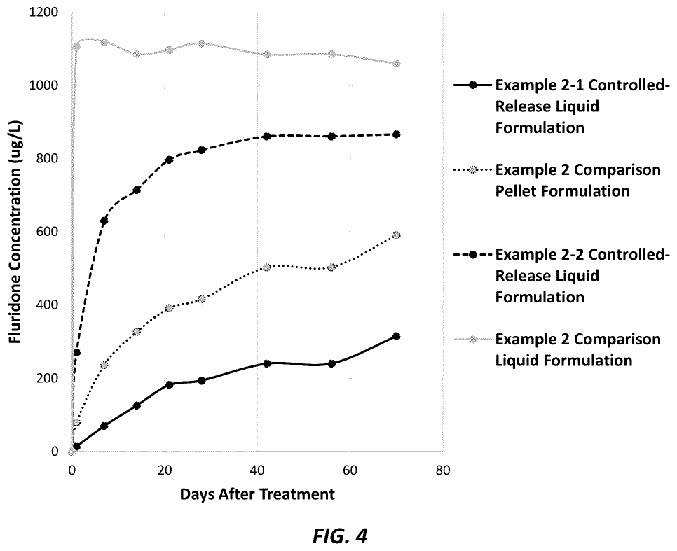

In an exemplary experiment, 52-L plastic tanks were filled with well water and treated with the Example 2-1 Controlled-Release Liquid Formulation, Example 2-2 Controlled-Release Liquid Formulation, a traditional liquid fluridone herbicide (SONAR GENESIS®, SePRO Corporation, Indiana, US) (“Example 2 Comparison Liquid Formulation”), and a traditional fluridone pellet (SONAR® SRP, SePRO Corporation, Indiana, US) (“Example 2 Comparison Pellet Formulation”) at 1000 μg fluridone/L. Water samples from the tanks were collected 1, 7, 14, 21, 28, 42, 56, and 70 days after treatment. Fluridone concentrations in the water samples were measured using high pressure liquid chromatography with a diode array detector (HPLC DAD). As shown in FIG. 4, both controlled-release formulations had slower release than the Example 2 Comparison Liquid Formulation. The Example 2-1 Controlled-Release Liquid Formulation displayed a slower release than the Example 2 Comparison Pellet Formulation. The Example 2-2 Controlled-Release Liquid Formulation had a release profile in between that of the Example 2 Comparison Liquid Formulation and the Example 2 Comparison Pellet Formulation. Thus, in one embodiment, a controlled-release liquid formulation of fluridone (for example, the Example 2-1 Controlled-Release Liquid Formulation or the Example 2-2 Controlled Release Liquid Formulation) is formulated to have a release profile that is slower than currently used liquid formulations but quicker than currently used pellets or slower than both currently used liquid and pellet formulations.

### EXAMPLE 3

In a fourth non-limiting example (Example 3), the controlled-release liquid formulation is a controlled-release liquid aquatic pesticide formulation that incudes dipotassium salt of endothall as the active ingredient and polyacrylate in the carrier (“Example 3 Controlled-Release Liquid Formulation”). In one embodiment, the controlled-release liquid formulation further includes at least one additional ingredient. In one embodiment, the additional ingredient is at least one of a dispersing agent, an antimicrobial agent, an antifoam agent, and a thickener. In one non-limiting example, the controlled-release liquid formulation is approximately 40.3% (±2%) dipotassium salt of endothall and approximately 4% (±0.5%) potassium polyacrylate, 0.1% (±0.01%) polydimethylsiloxane (for example, as an antifoam agent), 0.05% (±0.005%) xanthan gum (for example, as a thickener), 0.5% (±0.05%) polyoxyethylene isotridecyl ether together formed as particles having a particle size greater than approximately 250 μm and less than approximately 1000 μm (±25 μm), with the particles suspended in water with a pH of 7.5-8.5.

In an exemplary experiment in Example 3, the release profile of the Example 3 Controlled-Release Liquid Formulation was compared with a standard liquid endothall pesticide (AQUATHOL K®, UPL NA Inc.; the “Example 3 Comparison Formulation”). A specific amount of the Example 3 Controlled-Release Liquid Formulation (450 μL) was added to a first initial 100-mL borosilicate glass short cone oil centrifuge tube containing 100 mL of nanopure water (water purified using a Barnstead/Thermolyne Nanopure lab water system), and a specific amount of the Example 3 Comparison Formulation liquid endothall pesticide (450 μL) was added to another initial 100-mL borosilicate glass short cone oil centrifuge tube containing 100 mL of nanopure water. These amounts would be equivalent to a theoretical target treatment concentration of 1,000 mg endothall/L. Immediately after addition, a glass stopper was placed on each initial tube and the initial tubes were then gently inverted 180°. After 30 seconds following the inversion, the bottom 5 mL of liquid in the tube was pipetted into a different, untreated tube containing 95 mL nanopure water (second tube). Each of these different tubes were similarly capped and inverted 180° and a 5-mL aliquot was collected at 30 seconds and transferred to another different, untreated tube containing 95 mL nanopure water (third tube). Each of these different tubes were similarly capped and inverted 180° and a 5-mL aliquot was collected at 30 seconds and transferred to another different, untreated tube containing 95 mL nanopure water (fourth tube).

Tubes were homogenized prior to sampling at each post-treatment time point. Endothall was measured on an Dionex ICS-1500 brand ion chromatography instrument with an Dionex Ion Pac™ AS11-HC RFIC™ column. Endothall was then compared between treatment with the Example 3 Controlled-Release Liquid Formulation and the Example 3 Comparison Formulation.

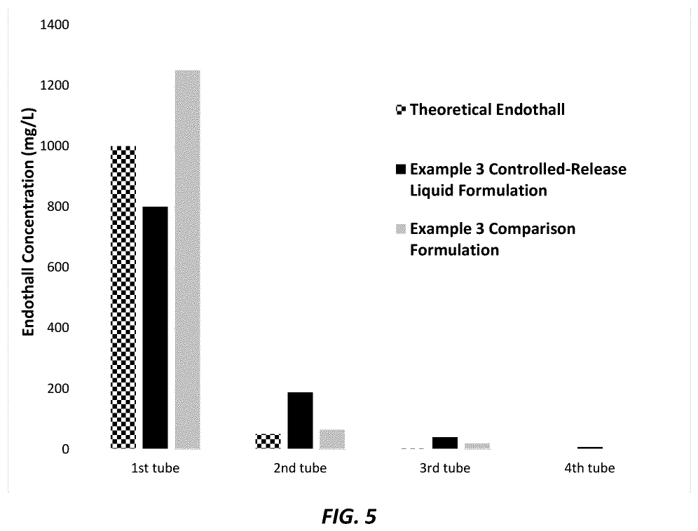

Continuing to refer to this exemplary experiment in Example 3, the endothall concentrations for the first tube treated with the Example 3 Controlled-Release Liquid Formulation were significantly below the targeted concentration as well as the concentration of endothall for the first tube treated with the Example 1 Comparison Formulation (1000 mg/L), suggesting that carrier material (containing endothall) had settled to the bottom of the tube and was transferred. The Example 3 Controlled-Release Liquid Formulation had an endothall concentration that was approximately 3.8 times greater than the theoretical concentration in the second tube, approximately 15.8 times greater than the theoretical concentration in the third tube, and 60.8 times greater than the theoretical concentration in the fourth tube, all of which were significantly higher than endothall concentrations in the first and second transfer tubes for the Example 3 Comparison Formulation. These results are shown in FIG. 5. This study shows a controlled release of endothall from the Example 3 Controlled-Release Liquid Formulation, due to its association with or binding by the carrier, in contrast with the theoretical results and the liquid endothall pesticide (Example 3 Comparison Formulation).

Embodiments

In one embodiment, a controlled-release liquid pesticide formulation includes: a first amount of an active ingredient; and a second amount of a non-aqueous carrier, the non-aqueous carrier including a plurality of particles having a size of between approximately 1 to 1,000 um in diameter.

In one aspect of the embodiment, the non-aqueous carrier includes a polymer, the carrier being suspended within a liquid.

In one aspect of the embodiment, the active ingredient is a pesticide.

In one aspect of the embodiment, the active ingredient is an aquatic herbicide.

In one aspect of the embodiment, the active ingredient is at least one active ingredient selected from the group consisting of: diquat dibromide, endothall, dipotassium salts of endothall, amine salts of endothall, copper, copper sulfate, copper chelated with ethylenediamine, copper chelated with monoethanolamine, copper chelated with triethanolamine, carfentrazone-ethyl, flumioxazin, 2,4-D, acids of 2,4-D, amine salts of 2,4-D, esters of 2,4-D, triclopyr, acids of triclopyr, amines of triclopyr, choline salts of triclopyr, glyphosate, imazapyr, imazamox, penoxsulam, fluridone, topramezone, bispyribac-sodium, sethoxydim, florpyrauxifen-benzyl, metsulfuron-methyl, and fluazifop-P-butyl.

In one aspect of the embodiment, the non-aqueous carrier is at least one of the following: a synthetic polymer, a natural polymer, a derivative of a natural polymer, a lipid, a lipid derivative, a hydrocarbon, a hydrocarbon derivative, an alcohol, an alcohol derivate, a sterol, a sterol derivative, a soap, a saponin, a soap derivative, a saponin derivative, a flavone, and a flavone derivative. In one aspect of the embodiment, the non-aqueous carrier is at least one of polyacrylate, polyvinyl acetate, a polydimethylsiloxane, a metasilicate, alginate, cellulose, chitin, latex, animal glue, collagen, methylcellulose, chitosan, gelatin, animal fat, vegetable oil, seed oil, a fatty acid metal complex, an esterified lipid, wax, petroleum distillate, an essential oil, glycerol-modified hydrocarbon.

In one aspect of the embodiment, the slow-release liquid pesticide formulation demonstrates targeted delivery of the pesticide, selectively increasing the pesticide active ingredient concentration in the bottom water or at the sediment-water interface relative to a standard liquid pesticide.

In one aspect of the embodiment, the active ingredient is ethylenediamine chelated copper and the non-aqueous carrier includes potassium polyacrylate.

In one aspect of the embodiment, the slow-release liquid pesticide formulation demonstrates sustained long-term delivery of the pesticide, in order to reduce off-site drift and/or diffusion into the water column of the pesticide active ingredient.

In one aspect of the embodiment, the active ingredient is fluridone and the carrier includes tall oil.

In one aspect of the embodiment, the active ingredient is endothall and the carrier includes polyacrylic acid.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

As used herein, “and/or” means “and” or “or”. For example, “A and/or B” means “A, B, or both A and B” and “A, B, C, and/or D” means “A, B, C, D, or a combination thereof” and said “A, B, C, D, or a combination thereof” means any subset of A, B, C, and D, for example, a single member subset (e.g., A or B or C or D), a two-member subset (e.g., A and B; A and C; etc.), or a three-member subset (e.g., A, B, and C; or A, B, and D; etc.), or all four members (e.g., A, B, C, and D).

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention.

What is claimed is:

1. A controlled-release liquid pesticide formulation, comprising:
an active ingredient; and
a non-aqueous carrier, the non-aqueous carrier including a plurality of particles having a size of between approximately 1 μm to approximately 1,000 μm.

2. The controlled-release liquid pesticide formulation of claim 1, wherein the non-aqueous carrier includes a polymer, the non-aqueous carrier being suspended within a liquid.

3. The controlled-release liquid pesticide formulation of claim 1, wherein the active ingredient is a pesticide.

4. The controlled-release liquid pesticide formulation of claim 1, wherein the active ingredient is at least one of an aquatic herbicide and an algaecide.

5. The controlled-release liquid pesticide formulation of claim 1, wherein the active ingredient is at least one active ingredient selected from the group consisting of: diquat dibromide, endothall, dipotassium salts of endothall, amine salts of endothall, copper, copper sulfate, copper chelated with ethylenediamine, copper chelated with monoethanolamine, copper chelated with triethanolamine, carfentrazone-ethyl, flumioxazin, 2,4-D, acids of 2,4-D, amine salts of 2,4-D, esters of 2,4-D, triclopyr, acids of triclopyr, amines of triclopyr, choline salts of triclopyr, glyphosate, imazapyr, imazamox, penoxsulam, fluridone, topramezone, bispyribac-sodium, sethoxydim, florpyrauxifen-benzyl, metsulfuron-methyl, and fluazifop-P-butyl.

6. The controlled-release liquid pesticide formulation of claim 1, wherein the non-aqueous carrier is at least one of the following: a synthetic polymer, a natural polymer, a derivative of a natural polymer, a fatty acid, a mixture of fatty acids, a lipid, a lipid derivative, a hydrocarbon, a hydrocarbon derivative, an alcohol, an alcohol derivate, a sterol, a sterol derivative, a soap, a saponin, a soap derivative, a saponin derivative, a flavone, and a flavone derivative, and mixtures thereof.

7. The controlled-release liquid pesticide formulation of claim 6, wherein the non-aqueous carrier is at least one of polyacrylate, polyvinyl acetate, a polydimethylsiloxane, a metasilicate, alginate, cellulose, chitin, latex, animal glue, collagen, methylcellulose, chitosan, gelatin, animal fat, vegetable oil, seed oil, a fatty acid metal complex, an esterified lipid, wax, petroleum distillate, an essential oil, glycerol-modified hydrocarbon.

8. The controlled-release liquid pesticide formulation of claim 1, further comprising water, the active ingredient being bound to the plurality of particles of the non-aqueous carrier, the active ingredient and the plurality of particles of the non-aqueous carrier being suspended in the water.

9. The controlled-release liquid pesticide formulation of claim 1, further comprising water, the water being present in an amount of approximately 45.2%, wherein:
the active ingredient is fluridone, the fluridone being present in an amount of approximately 41.7%;
the non-aqueous carrier includes:
tall oil, the tall oil being present in an amount of approximately 7%;
calcium carbonate, the calcium carbonate being present in an amount of approximately 5%; and
at least one of ethoxylated tridecanol, 1,2-benzisothiazol-3(2H)-one, 5-chloro-2-methyl-2H-isothiazolin-3-one, polydimethylsiloxane, and xanthan gum.

10. The controlled-release liquid pesticide formulation of claim 1, wherein the controlled-release liquid pesticide formulation is configured such that the active ingredient accumulates in a bottom water or at a sediment-water interface relative to a standard liquid pesticide.

11. The controlled-release liquid pesticide formulation of claim 1, wherein the active ingredient is ethylenediamine chelated copper and the non-aqueous carrier includes potassium polyacrylate.

12. The controlled-release liquid pesticide formulation of claim 11, further comprising an antifoam agent.

13. The controlled-release liquid pesticide formulation of claim 1, wherein the controlled-release liquid pesticide formulation is formulated such that the active ingredient is released from the controlled-release liquid pesticide formulation slowly over time to reduce off-site drift and/or diffusion into a water column of the pesticide active ingredient.

14. The controlled-release liquid pesticide formulation of claim 1, wherein the active ingredient is fluridone and the non-aqueous carrier includes tall oil and calcium carbonate.

15. The controlled-release liquid pesticide formulation of claim 14, wherein the non-aqueous carrier further includes at least one of a dispersing agent, an antimicrobial agent, an antifoam agent, and a thickener.

16. The controlled-release liquid pesticide formulation of claim 1, wherein the active ingredient is endothall and the non-aqueous carrier includes potassium polyacrylate.

17. The controlled-release liquid pesticide formulation of claim 16, wherein the carrier further includes at least one of poldimethylysiloxane, xanthan gum, and polyoxyethylene isotridecyl ether.

18. A controlled-release liquid pesticide formulation, comprising:
an active ingredient, the active ingredient being ethylenediamine chelated copper; and
a non-aqueous carrier, the non-aqueous carrier including a plurality of particles having a size of between approximately 1 μm to approximately 1,000 μm, the non-aqueous carrier including potassium polyacrylate, the controlled-release liquid pesticide formulation having a form of sprayable pellets.

19. The controlled-release liquid pesticide formulation of claim 18, further comprising water and an antifoam agent, wherein:
the ethylenediamine chelated copper is present in an amount of approximately 20-23% by weight;
the potassium polyacrylate is present in an amount of approximately 1-3%;
the antifoam agent is present in an amount of approximately 0.1-2%; and
the water is present in an amount of approximately 60-80%.

20. A controlled-release liquid pesticide formulation, comprising:
an active ingredient, the active ingredient being endothall; and
a non-aqueous carrier, the non-aqueous carrier including a plurality of particles having a size of between approximately 1 μm to approximately 1,000 μm, the non-aqueous carrier including potassium polyacrylate.

21. The controlled-release liquid pesticide formulation of claim 20, further comprising water, and the non-aqueous carrier further including at least one of polydimethylsiloxane, xanthan gum, and polyoxyethylene isotridecyl ether wherein:
the endothall is present in an amount of approximately 40.3%; and
the potassium polyacrylate is present in an amount of approximately 4%.
